(19) United States
(12) Patent Application Publication
(10) Pub. No.: US 2012/0188752 A1
(43) Pub. Date: Jul. 26, 2012

(54) LIGHTING APPARATUS WITH HYBRID POWER SUPPLY DEVICE, AND METHOD UTILIZING THE SAME

(76) Inventor: CHIA-TEH CHEN, TAIPEI (TW)

(21) Appl. No.: 13/013,908

(22) Filed: Jan. 26, 2011

(51) Int. Cl. F21L 4/08; F21L 4/00

(52) U.S. Cl. 362/183; 362/157

(57) ABSTRACT

A light apparatus with a hybrid power supply device and method utilizing the same are disclosed. The light apparatus includes an LED module, a solar module, an auxiliary power module, a voltage level detection circuit, a first switch unit, and a second switch unit. When a voltage of a solar electric power generated by the solar module is greater than a predetermined value, the voltage level detection circuit provides an electrical connection between the solar module and the LED module for enabling a transmission of the solar electric power to the LED module. When the voltage of the solar electric power is smaller than the predetermined value, the voltage level detection circuit provides an electrical connection between the auxiliary power module and the LED module for enabling a transmission of an auxiliary electric power generated by the auxiliary power module to the LED module.

### BACKGROUND OF THE INVENTION

1. Field of the Invention

The present disclosure relates to a lighting apparatus, especially to a lighting apparatus with a hybrid power supply device and a method utilizing the same.

2. Description of Related Art

Solar power supply has been adopted as an environmental-friendly source for powering lighting apparatus such as light-emitting diode (LED). However, the amount of electric power that could be provided by the solar power supply is limited by factors including intensity and length of sun light. If it's a cloudy day or the day length is not long enough, the electric power stored in the power storage unit of the solar power supply may not be sufficient enough to drive the LED.

Conventional lighting devices may be a combination of a solar module and wind a power module. The electric power generated by the solar module and the wind power module is stored in rechargeable batteries, for providing requisite electric power to the LED. However, if the daylight intensity and wind force are not sufficient enough at the same time, the solar module and the wind power module may stop operating. That is, using solar and wind power modules together for power supply may still be influenced by weather conditions, failing to ensure the continuity of the delivery of the electrical power to the lighting device.

### SUMMARY OF THE INVENTION

An exemplary embodiment according to the present disclosure describes a lighting apparatus, a hybrid power supply device and method utilizing the same, for providing a stable power source.

The apparatus disclosed in one embodiment of the present disclosure includes a light-emitting diode (LED) module, a solar module, an auxiliary power module, and an electric power selection circuit. The solar module is electrically selectable connecting to the LED module. The auxiliary power module is connected to an exterior power source, and also electrically selectable connecting to the LED module. The electric power selection circuit is electrically connected to the solar module, the auxiliary power module, and the LED module.

The solar module is for receiving light energy and converting the light energy into electrical energy, in order to generate a solar electric power. The generated solar electric power is then transmitted to LED module. The auxiliary power module is for receiving the power of an exterior power source and transmitting an auxiliary electric power to the LED module. The electric power selection circuit is for determining whether to provide the solar electric power or the auxiliary electric power to the LED module.

According to another exemplary embodiment of the present disclosure, a hybrid power supply device is provided. The device includes a solar module, an auxiliary power module, and an electric power selection circuit. The hybrid power supply device is electrically connected to a power utilizing load. The auxiliary power module is electrically connected to an exterior power source. The electric power selection circuit is electrically connected to the solar module, the auxiliary power module, and the power utilizing load.

The solar module is for receiving light energy and converting the light energy into electrical energy, in order to output a solar electric power. The auxiliary power module is for receiving the power of the exterior power source to generate an auxiliary electric power. The electric power selection circuit is for determining whether to provide the solar electric power or the auxiliary electric power to the power utilizing load.

According to still another exemplary embodiment of the present disclosure, a hybrid power supply method is presented. The method is associated with a hybrid power supply device for providing electric power to an LED module. The device includes a solar module, an auxiliary power module, a first switch unit, a second switch unit, and a voltage level detection circuit. The first switch unit is electrically connected between the solar module and the LED module, and the second switch unit is electrically connected between the auxiliary power module and the LED module. The hybrid power supply method includes comparing a voltage of a solar electric power generated by the solar module with a predetermined value by the voltage level detection circuit, for generating a comparison result. In addition, the method further includes controlling the first switch unit and the second switch unit according to the comparison result by the voltage level detection circuit, for determining whether to provide the solar electric power generated by the solar module or an auxiliary electric power generated by the auxiliary power module to the LED module.

As mentioned above, the exemplary embodiments according to the present disclosure relate to the hybrid power supply capable of providing stable electric power to LED module.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a block diagram of a lighting apparatus with a hybrid power supply according to an exemplary embodiment of the present disclosure;

FIG. 2 is a block diagram of a lighting apparatus with a hybrid power supply according to another exemplary embodiment of the present disclosure;

FIG. 3 is a flow chart of a method for operating a hybrid power supply according to an exemplary embodiment of the present disclosure;

FIG. 4 is a circuit diagram of a lighting apparatus with a hybrid power supply according to an exemplary embodiment of the present disclosure; and

FIG. 5 is a device diagram of a lighting apparatus with a hybrid power supply according to an exemplary embodiment of the present disclosure.

### DETAILED DESCRIPTION OF THE PREFERRED EMBODIMENTS

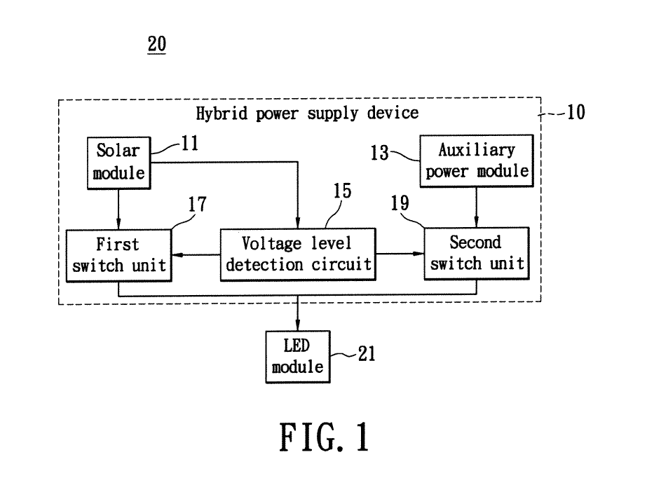

Refer to FIG. 1. FIG. 1 is a block diagram of a lighting apparatus 20 with a hybrid power supply according to an exemplary embodiment of the present disclosure. The lighting apparatus 20 includes a hybrid power supply device 10 and a light-emitting diode (LED) module 21. The hybrid power supply device 10 further has a solar module 11, an auxiliary power module 13, a voltage level detection circuit 15, a first switch unit 17, and a second switch unit 19. The solar module 11 and the auxiliary power module 13 are connected to the LED module 21 through the first switch unit 17 and the second switch unit 19, respectively. The first switch unit 17 is electrically connected between the solar module 11 and the LED module 21, and the second switch unit 19 is electrically connected between the auxiliary power module 13 and the LED module 21. The voltage level detection circuit 15 is electrically connected to the solar module 11, the first switch unit 17, and the second switch unit 19.

In the present embodiment, the solar module 11 is for converting light energy into electrical energy, in order to provide electric power to the LED module 21. The auxiliary power module 13 is connected to an exterior power source that may be an alternative current (AC) or a direct current (DC) power source. The auxiliary power module receives the electric power transmitted from the exterior power source for generating a DC auxiliary electric power, in order to provide requisite operating electric power to the LED module 21 when the voltage of a solar electric power generated by the solar module 11 is not enough. The LED module 21 is used as an example of a power utilizing load of the hybrid power supply device 10. However, although FIG. 1 involves the LED module 21 as a power utilizing load, the power utilizing load of the present disclosure is not limited to the LED module 21.

The voltage level detection circuit 15 is configured to turn on or turn off the first switch unit 17 and the second switch unit 19 according to a voltage delivered by the solar module 11, for determining whether to transmit the solar electric power generated by the solar module 11 or the DC auxiliary electric power generated by the auxiliary power module 13 to the LED module 21.

For example, when the voltage level detection circuit 15 detects that the voltage delivered by the solar module 11 is smaller than a predetermined value, the voltage level detection circuit 15 turns off the first switch unit 17. As such, the connection between the solar module 11 and the LED module 21 is cut off. At the same time, the voltage level detection circuit 15 turns on the second switch unit 19, for facilitating an electrical connection between the auxiliary power module 13 and the LED module 21. Therefore, the hybrid power supply device 10 may provide the requisite electric power to the LED module 21 by the auxiliary power module 13. On the other hand, when the voltage level detection circuit 15 detects the voltage delivered by the solar module 11 is greater than the predetermined value, the first switch unit 17 is turned on while the second switch unit 19 is turned off. Thus, the connection between the auxiliary power module 13 and the LED module 21 is cut off, and the solar electric power generated by the solar module 11 may be provided to the LED module 21. In other words, the hybrid power supply device 10 may provide the requisite electric power to the LED module through the solar module 11.

Additionally, in another embodiment, the first switch unit 17 and the second switch unit 19 may be replaced by a 2-to-1 multiplexer having a first input end, a second input end, a control end, and an output end. The first input end is electrically connected to the solar module 11, while the second input end is electrically connected to the auxiliary power module 13. Also, the control end is electrically connected to the voltage level detection circuit 15, with the output end is electrically connected to the LED module 21. The voltage level detection circuit 15 generates a selection signal to the control end according to the voltage delivered by the solar module 11. After the control end receives the selection signal, the multiplexer generates a link connecting the output end with the first input end, or with the second input end.

More specifically, the voltage level detection circuit 15, the first switch unit 17, and the second switch unit 19 may serve as an electric power selection circuit. The electric power selection circuit may be used to determine whether the solar electric power or the auxiliary electric power would be delivered to the LED module 21. Although FIG. 1 only shows the voltage level detection circuit 15, the first switch unit 17, and the second switch unit 19 for implementing the electric power selection circuit, the implementation of the electric power selection circuit is not limited as such.

Moreover, the hybrid power supply device 10 may further include power modules other than the solar module 11 and the auxiliary power module 13. In one implementation, the hybrid power supply device 10 may have a wind power module.

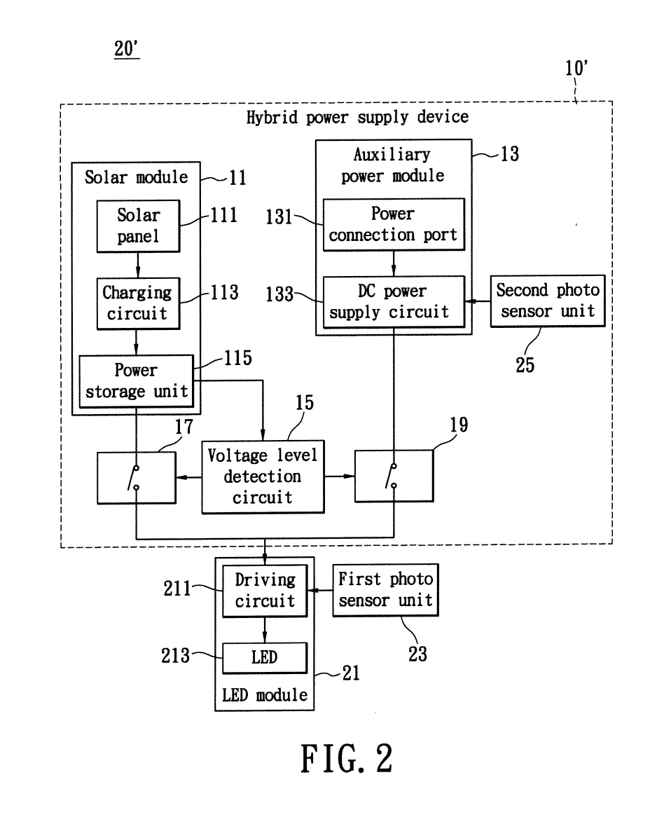

Refer to FIG. 2. FIG. 2 is a block diagram of a lighting apparatus 20′ with a hybrid power supply according to another exemplary embodiment of the present disclosure. The lighting apparatus 20′ with the hybrid power supply includes a hybrid power supply device 10′ and an LED module 21. The hybrid power supply device 10′ has a solar module 11, an auxiliary power module 13, a voltage level detection circuit 15, a first switch unit 17, and a second switch unit 19. The solar module 11 includes a solar panel 111, a charging circuit 113, and a power storage unit 115. The auxiliary power module 13 includes a power source connection port 131 and a direct current (DC) power supply circuit 133. The LED module 21 includes a driving circuit 211 and at least one LED 213.

The solar module 11 and the auxiliary power module 13 are connected to the LED module 21 through the first switch unit 17 and the second switch unit 19, respectively. The first switch unit 17 is electrically connected between the solar module 11 and the LED module 21, and the second switch unit 19 is electrically connected between the auxiliary power source 13 and the LED module 21. The voltage level detection circuit 15 is electrically connected to the solar module 11, the first switch unit 17, and the second switch unit 19. The solar panel 111 is electrically connected to the charging circuit 113, the charging circuit 113 is electrically connected to the power storage unit 115, and the power storage unit 115 is electrically connected to the first switch unit 17 and the voltage level detection circuit 15. The DC power supply circuit 133 is electrically connected to the power source connection port 131 and the second switch unit 19. The driving circuit 211 is electrically connected to the first switch unit 17, the second switch unit 19, and the LED 213.

The solar panel 111 is a device for implementing an optical-to-electrical conversion. Light energy is converted into electrical energy by the solar panel 111, and the generated electrical energy is then transmitted and stored in the power storage unit 115 by the charging circuit 113. In one implementation, the power storage unit 115 is a rechargeable battery. The charging circuit 113 may have a diode (not shown in FIG. 2) for avoiding the electric power stored in the power storage unit 115 from flowing back to solar panel 111.

The power source connection port 131 is for connecting an AC or a DC exterior power source, and transmitting the electric power to the DC power supply circuit 133. The DC power supply circuit 133 may also include a transformer and a rectifier, both of which could handle the AC power input if the power source connection port 131 connects to the AC power source. The DC power supply circuit 133 is for generating an operating voltage of the hybrid power supply device 10′, and for generating the auxiliary electric power provided to the LED module 21. In one implementation, the auxiliary electric power is a DC power.

The driving circuit 211 may be a driving IC for the LED 213. The driving circuit 211 receives the solar electric power transmitted from the solar module 11 or the auxiliary electric power transmitted from the auxiliary power module 13, for driving the LED 213. The voltage level detection circuit 15 compares the voltage of the solar electric power with the predetermined value before controlling operations of the first switch unit 17 and the second switch unit 19. Therefore, whether the solar electric power or the auxiliary electric power is transmitted to the driving circuit 211 may be determined.

In addition, the lighting apparatus 20′ may further have a first photo sensor unit 23 and a second photo sensor unit 25. The first photo sensor unit 23 is electrically connected to the driving circuit 211, and the second photo sensor unit 25 is electrically connected to the DC power supply circuit 133. The first photo sensor unit 23 is for detecting an environmental light intensity, and for stopping the driving circuit 211 from operating when the environmental light intensity is greater than a predetermined first threshold value. Thus, the LED module 21 may not operate in an environmental with the environmental light intensity being strong enough. Similarly, the second photo sensor unit 25 is for stopping the DC power supply circuit 133 from providing the electric power when the environmental light intensity is greater than a predetermined second threshold value. Consequently, with the thresholds in place unexpected power waste may be reduced.

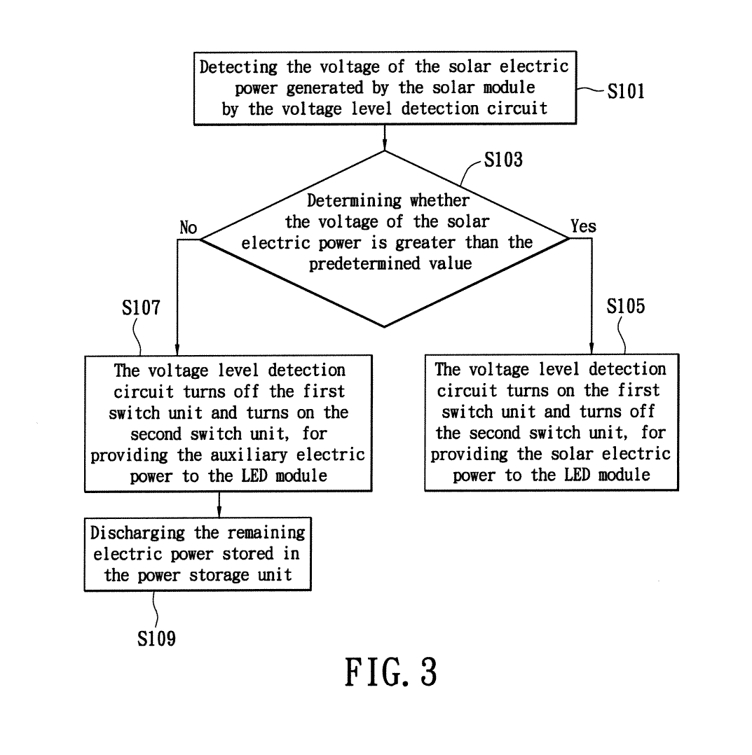

In conjunction with FIG. 1, refer to FIG. 3. FIG. 3 is a flow chart of a method for operating a hybrid power supply according to an exemplary embodiment of the present disclosure. The method includes detecting the voltage of the solar electric power generated by the solar module 11 (S101) by the voltage level detection circuit 15. The method further include determining whether the voltage of the solar electric power is greater than a predetermined value by the voltage level detection circuit 15 (S103), before generating a comparison result. When the voltage of the solar electric power is greater than the predetermined value, the electric power stored in the power storage unit 115 of the solar module 11 may be considered sufficient enough for providing the requisite electric power to the LED module 21. When the voltage of the solar electric power is greater than the predetermined value, the method of the present disclosure may cause the voltage level detection circuit 15 to turn on the first switch unit 17 and to turn off the second switch unit 19, for providing the solar electric power to the LED module 21 (S105).

On the other hand, when the voltage of the solar electric power is smaller than the predetermined value the amount of electric power stored in the power storage unit 115 may not be sufficient enough for providing the requisite electric power to the LED module 21. Thus, the method of the present disclosure may cause the voltage level detection circuit 15 to turn off the first switch unit 17 and to turn on the second switch unit 19, for providing the auxiliary electric power generated by the auxiliary power module 13 to the LED module 21 (S107). When the hybrid power supply device 10 utilizes the auxiliary power module 13 to provide the requisite electric power, the hybrid power supply method may further includes discharging the power storage unit 115 by a power leakage unit (S109). Discharging the remaining power of the power storage unit 115 is for avoiding the memory effect which may occur in the power storage unit 115. The memory effect of some rechargeable batteries may result in a reduction of the number of times the power storage unit 115 could be recharged.

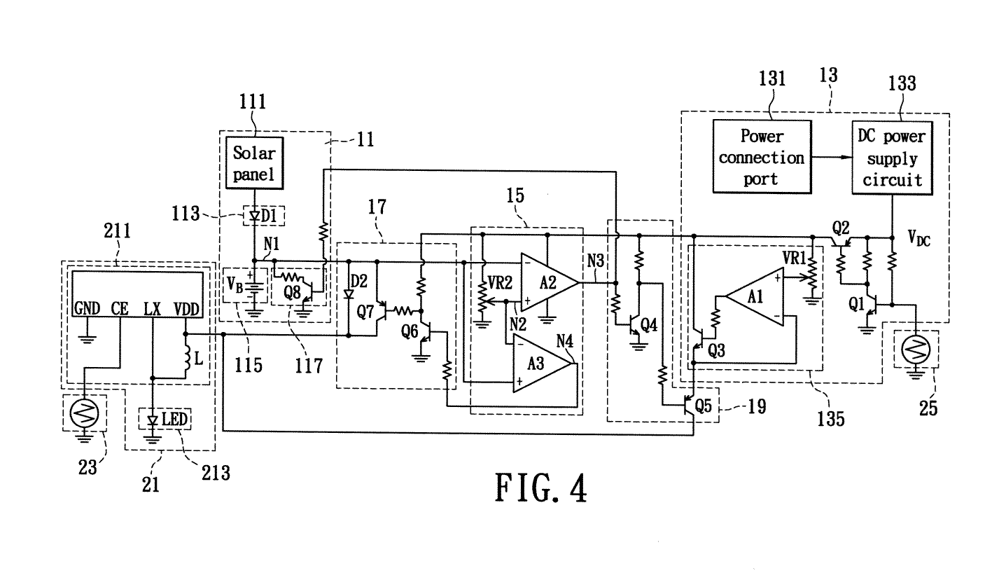

Refer to FIG. 4. FIG. 4 is a circuit diagram of a lighting apparatus with a hybrid power supply according to an exemplary embodiment of the present disclosure. As shown in FIG. 4, the charging circuit 113 of the solar module 11 may be a diode D₁, and the power storage unit 115 may be a rechargeable battery. The rechargeable battery has one end connected to ground and another end connected to the diode D₁, and designated as high voltage level node N₁. The potential difference between the ground and the high voltage level node N₁ is the output voltage of the rechargeable battery, namely, the voltage of the solar electric power described above. Suppose the voltage of the fully charged rechargeable battery is V_{B0} and at the time of detection the voltage of the rechargeable battery is V_{B}, which is supposed to be equal to or less than the voltage V_{B0}. The high voltage level node N₁ is connected to an inverting input of the amplifier A₂ in the voltage level detection circuit 15, so that the voltage level detection circuit 15 may detect the voltage V_{B}. It is worth noting that the placement of the diode D₁ may avoid the electric power stored in the power storage unit 115 from flowing back to the solar panel 111.

The auxiliary power module 13 may further include a voltage adjusting circuit 135. The voltage adjusting circuit 135 has an amplifier A₁, a transistor Q₃, and a variable resistor VR₁. The amplifier A₁ has a non-inverting input connected to the variable resistor VR₁. Further, the amplifier A₁ has an inverting input connected to an emitter of the transistor Q₃ and an output connected to a base of the transistor Q₃ through a resistor for establishing a feedback connection. In addition, a collector of the transistor Q₃ is connected to the transistor Q₂. The voltage adjusting circuit 135 is for adjusting a voltage level of an output voltage and thus that particular output voltage may be used by the LED module 21. The auxiliary electric power or the adjusted output voltage may then be transmitted to the second switch unit 19. With the voltage adjusting circuit 135, the auxiliary power module 13 may meet different output voltage level of the solar module 11 of different standards.

Additionally, besides connecting to the inverting input of the amplifier A₁, the emitter of the transistor Q₃ further connects to an emitter of the transistor Q₅ in the second switch unit 19. Fixed contacts of the variable resistor VR₁ are respectively connected to a collector of transistor Q₂ and the ground, and a sliding contact of the variable resistor VR₁ is connected to the non-inverting input of the amplifier A₁. Accordingly, a voltage divider may be established. When the resistance of the variable resistor VR₁ changes, the voltage at the non-inverting input of the amplifier A₁ may be adjusted as the result. When the amplifier A₁ operates at a linear region, the voltage at the inverting input of amplifier A₁ approximately equals to the voltage at the non-inverting input of the amplifier A₁. Therefore, if the voltage of the non-inverting input of the amplifier A₁ is adjusted to V_{B0} which may correspond to the voltage of the fully charged power storage unit 115, the voltage outputted from the emitter of the transistor Q₃ may approximately be the same as the voltage V_{B0}. Therefore, the voltage outputted from the auxiliary power module 13 to the second switch unit 19 through transistor Q₃ may be regulated for matching different requirements.

The voltage V_{DC} generated from the DC power supply circuit 133 of the auxiliary power module 13 is designed to be greater than the voltage V_{B0} delivered from the solar module 11. In doing so, the voltage V_{DC} could be sufficiently high enough for providing operating voltages for each element in the lighting apparatus and could be also adjusted to the voltage level of V_{B0}.

Moreover, as shown in FIG. 4, the auxiliary power module 13 may further include transistors Q₁ and Q₂, and a photo sensor unit 25, for controlling the transmission of the generated DC voltage V_{DC}. In one implementation, the photo sensor unit 25 may be a light dependent resistor (LDR). When the environmental light intensity is strong, the photo sensor unit 25 may be associated with a low resistance. Therefore, the voltage difference between the base and the emitter node of the transistor Q₁ is small. Then, the transistor Q₁ is turned off. When the transistor Q₁ is off, the current at the collector node of the transistor Q₁ is zero and the potential at the base node and the emitter node of the transistor Q₂ may be equal to each other, such that the transistor Q₂ is also turned off. Because the current flowing from the emitter of the transistor Q₂ to the collector thereof is zero, the transmission of voltage V_{DC} may stop. On the other hand, the weak environmental light intensity may associate the photo sensor unit 25 with high resistance. Therefore, the voltage difference between the base node and the emitter node of the transistor Q₁ is high. Then, the transistor Q₁ is turned on, such that the voltage of the collector node of transistor Q₁ is close to ground. Therefore, the voltage difference between the base and the emitter of the transistor Q₂ may be sufficient to turn on the transistor Q₂. As such, the voltage V_{DC} may be transmitted from the emitter to the collector of the transistor Q₂, for providing the operating voltages to the voltage level detection circuit 15, the first switch unit 17, and the second switch unit 19, and further rendering the voltage adjusting circuit 135 to deliver a voltage equal to the voltage V_{B0} of the solar module 11.

Refer to FIG. 4 again. The voltage level detection circuit 15 includes amplifier A₂ and A₃. An inverting input of the amplifier A₂ is connected to the high voltage node N₁ which is the output of the solar module 11, and a non-inverting input of the amplifier A₂ is connected to the node N₂ of a variable resistor VR₂. On the contrary, the high voltage node N₁ is connected to a non-inverting input of the amplifier A₃ while and an inverting input of the amplifier A₃ is connected to the node N₂ of the variable resistor VR₂. In addition, the first switch unit 17 includes transistors Q₆ and Q₇, and the second switch unit 19 includes transistors Q₄ and Q₅.

The voltage level detection circuit 15 detects the value of the voltage V_{B} of the solar module 11, and sets the first switch unit 17 and the second switch unit 19 on or off, respectively, according to the detected value of the voltage V_{B}. The voltage provided by node N₂ may serve as the predetermined value, which may be compared with the voltage V_{B}. The voltage at node N₂ may be considered as a minimum requisite voltage for the driving circuit 211 of the LED module 21, and may be adjusted by the variable resistor VR₂. Generally, the voltage of the node N₂ may be set to 0.7 times of the voltage V_{B0}. Of course, the voltage of the node N₂ may be set to any other value depending on practical needs or design schemes.

Additionally, an output node N₃ of the amplifier A₂ is connected to a base node of the transistor Q₄ of the second switch unit 19 through a resistor. In the second switch unit 19, an emitter of the transistor Q₄ is connected to the ground, and a collector of the transistor Q₄ is connected to a base of the transistor Q₅ and through a resistor to the voltage V_{Dc}. An emitter of transistor Q₅ is connected to the transistor Q₃ of the auxiliary power module 13, and a collector of transistor Q₅ is connected to the driving circuit 211 of the LED module 21. The non-inverting input of the amplifier A₃ is also connected to the high voltage level node N1, and the inverting input of the amplifier A₃ to the node N₂ of the variable resistor VR₂. Further, an output node N₄ of the amplifier A₃ is connected to a base of the transistor Q₆ of the first switch unit 17 through a resistor. In the first switch unit 17, an emitter of the transistor Q₆ is connected to the ground, and a collector of the transistor Q₆ is connected through a resistor to the voltage V₇ and also through a resistor to a base of the transistor Q₇. An emitter of the transistor Q₇ is connected to the high voltage level node N₁, and a collector of the transistor Q₇ is connected to the driving circuit 211.

When the solar electric power provided by the solar module 11 is sufficient, namely, at the time the voltage V_{B} of the solar electric power is greater than the predetermined value provided by the node N₂, the voltage of output node N₄ of the amplifier A₃ is “high”. This turns on the transistor Q₆ that is connected to N₄. Then, the voltage at the base node of transistor Q₇ is low. As such, the transistor Q₇ is turned on also. Therefore, the voltage V_{B} of the solar electric power is transmitted from the solar module 11 to the driving circuit 211 of the LED module 21 through the first switch unit 17.

When the voltage V_{B} of the solar electric power is greater than the predetermined value provided by the node N₂, the voltage of the output node N₃ of the amplifier A₂ is “low”. Thus, the transistor Q₄ is turned off, and the voltage of the base of the transistor Q₅ is high, turning off the transistor Q₅ as the result. And therefore the connection between the auxiliary power module 13 and the driving circuit 211 of the LED module 21 is cut off by the second switch unit 19.

On the other hand, when the solar electric power provided by the solar module 11 is insufficient, (i.e., when the voltage V_{B} of the solar electric power is smaller than the predetermined value provided by the node N₂) the voltage of the output node N₄ of amplifier A₃ is “low.” As such, the transistors Q₆ and Q₇ are turned off, effectively disconnecting the solar module 11 from the driving circuit 211 of the LED module 21.

When the voltage V_{B} of the solar electric power is smaller than the predetermined value provided by the node N₂, the voltage of the output node N₃ of the amplifier A₂ is “high.” Thus, the transistor Q₄ is turned on, and the voltage of the base of the transistor Q₅ is low. Then, the transistor Q₅ is turned on. Since the transistor Q₅ is connected to the transistor Q₃, the voltage at the emitter of the transistor Q₃, which is set to the value of V_{B0} by the operation of the voltage adjusting circuit 135 described above, may be transmitted through the transistor Q₅. Consequently, the auxiliary power module 13 may transmit the auxiliary electric power of the voltage V_{B0} to the driving circuit 211 of LED module 21 through the second switch unit 19.

Briefly speaking, when the output voltage V_{B} of the solar module 11 is greater than the predetermined value provided by the node N₂, the hybrid power supply device 10 may turn to the solar module 11 for providing the electric power to the LED module 21. On the other hand, when the output voltage V_{B} of the solar module 11 is smaller than the predetermined value provided by the node N₂, the hybrid power supply device 10 utilizes the auxiliary power module 13 for providing the electric power to the LED module 21. It is worth noting that the predetermined value provided by the node N₂ may be set to the minimum requisite voltage for driving the LED module 21, or may be set to any other value according to practical needs or design schemes.

In addition, in this exemplary embodiment, the solar module 11 may further include a power leakage unit 117, for protecting the power storage unit 115 which may be a rechargeable Ni—Cd battery in one implementation. As shown in FIG. 4, the power storage unit 115 of the solar module 11 is parallel connected with the power leakage unit 117 which includes a transistor Q₈ and a resistor. A base node of the transistor Q₈ is connected to the output node N₃ of the amplifier A₂ of the voltage level detection circuit 15 through another resistor. When the voltage V_{B} of the solar electric power delivered by the solar module 11 is greater than the predetermined value provided by the node N₂, the output node N₃ of the amplifier A₂ may yield a “low” voltage to turn off the transistor Q₈. In other words, when the output of the solar module 11 maintains a sufficient voltage level, the power leakage unit 117 is turned off.

When the voltage V_{B} generated by the solar module 11 is smaller than the predetermined value, the output node N₃ of the amplifier A₂ yields a “high” level voltage to turn on both the second switch unit 19 and the transistor Q₈. Therefore, when the auxiliary power module 13 is used for providing the electric power to LED module 21, the remaining electric power stored in the power storage unit 115 may be discharged through the path provided by the transistor Q₈. The resistor connected to the collector node of the transistor Q₈ in the power leakage unit 117 is for controlling the discharging rate. Consequently, the power leakage unit 117 may serve as a useful means to extend the lifetime of the power storage unit 115.

The first switch unit 17 may further include a diode D₂ connected between the emitter and the collector of the transistor Q₇. The diode D₂ is turned on when the auxiliary power module 13 does not facilitate the connection between the solar module 11 and the LED module 21. The diode D₂ is turned off by a reverse bias voltage when the voltage V_{B} decreases and the second switch unit 19 is turned on. When the first switch unit 17 is turned on, the electric power provided by the solar module 11 may be delivered to the LED module 21 through the transistor Q₇. The benefit of providing the diode D₂ is that when the auxiliary power module 13 work abnormally and stops providing the electric power to the first switch unit 17, the second switch unit 19, and the voltage level detection unit 15, the solar module 11 may still transmit the solar electric power to the LED module 21 through the diode D₂, maintaining the continuity of the delivery of the electric power to the LED module 21.

Furthermore, in the exemplary embodiment presented in FIG. 4, the driving circuit 21 may be implemented by an integrated circuit (IC) of the type ANA618. An operating power node V_{DD} of the IC is connected to the solar module 11 and the auxiliary power module 13 through the first switch unit 17 and the second switch unit 19, respectively. In addition, a node LX of the IC is connected to the LED 213, and is also connected to the node V_{DD} through an inductor. The photo sensor unit 23 is connected to a node CE of the same IC, for controlling the driving circuit 211 to operate only when the environmental light intensity is low. Additionally, the amplifiers A1, A2, and A3 may be implemented by one IC, such as the type LM324, for simplifying the circuit design.

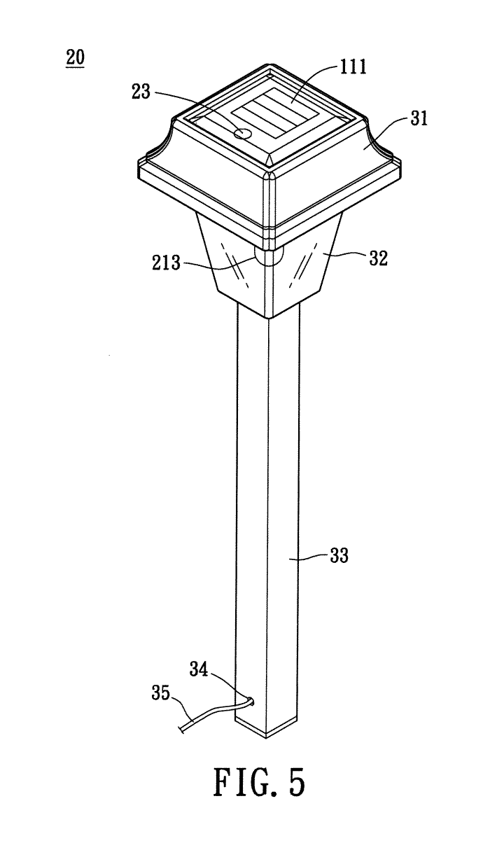

Refer to FIG. 5 and FIG. 4. FIG. 5 is a device diagram of a light apparatus 20 with a hybrid power supply according to an exemplary embodiment of the present disclosure. The lighting apparatus 20 in FIG. 5 is a garden lamp, which includes a solar panel 111, a photo sensor unit 23, an LED 213, a top section 31, a shield 32, a pillar 33, an aperture 34, and a wire 35 of the power connection port 131. The circuit of the hybrid power supply device 10 may be installed in the space between the top section 31 and the shield 32.

The solar panel 111 may convert the light energy into the electrical energy, and transmit the electrical energy to the power storage unit 115, for delivering the solar electric power to power up the LED 213. When the voltage of the solar electric power is too low and cannot provide the requisite electric power to LED 213 for light emitting purpose, the auxiliary power module 13 of the hybrid power supply device 10 may receive power from the wire 35, so as to make the auxiliary electric power ready for the LED 213. In addition, when the photo sensor unit 23 detects that the environmental light intensity is greater than a threshold value, the photo sensor unit 23 may stop the LED 213 from emitting light, for avoiding electric power waste.

Some modifications of these examples, as well as other possibilities will, on reading or having read this description, or having comprehended these examples, will occur to those skilled in the art. Such modifications and variations are comprehended within this invention as described here and claimed below. The description above illustrates only a relative few specific embodiments and examples of the invention. The invention, indeed, does include various modifications and variations made to the structures and operations described herein, which still fall within the scope of the invention as defined in the following claims.

What is claimed is:

1. A lighting apparatus with hybrid power supply, comprising:
a light-emitting diode (LED) module;
a solar module, electrically connected to the LED module, in which the solar module receives a light energy and converts the light energy into electrical energy before outputting a solar electric power and transmitting the solar electric power to the LED module;
an auxiliary power module, electrically connected to the LED module and an exterior power source, in which the auxiliary power module receives a power of the exterior power source and transmits an auxiliary electric power to the LED module; and
an electric power selection circuit electrically connected to the LED module, the solar module, and the auxiliary power module, in which the electric power selection circuit determines whether to transmit the auxiliary electric power or the solar electric power to the LED module according to a voltage of the solar electric power.

2. The lighting apparatus as in claim 1, wherein the electric power selection circuit comprises:
a first switch unit, electrically connected between the LED module and the solar module;
a second switch unit, electrically connected between the LED module and the auxiliary power module; and
a voltage level detection circuit, electrically connected to the solar module, the first switch unit, and the second switch unit, in which the voltage level detection circuit compares the voltage of the solar electric power outputted by the solar module with a predetermined value before preparing a comparison result, which serves as a basis for a control of the first switch unit and the second switch unit.

3. The lighting apparatus as in claim 1, wherein the electric power selection circuit comprises:
a 2-to-1 multiplexer, having a first input end electrically connected to the solar module, a second input end electrically connected to the auxiliary power module, a control end, and an output end electrically connected to the LED module; and
a voltage level detection circuit, electrically connected to the solar module and the control end, in which the voltage level detection circuit generates a selection signal according to the voltage of the solar electric power outputted by the solar module, and controls the 2-to-1 multiplexer for outputting the auxiliary electric power or the solar electric power to the LED module according to the selection signal.

4. The lighting apparatus as in claim 2, wherein if the comparison result indicates that the voltage of the solar electric power is greater than the predetermined value, the voltage level detection circuit turns on the first switch unit and turns off the second switch unit, otherwise the voltage level detection circuit turns off the first switch unit and turns on the second switch unit.

5. The lighting apparatus as in claim 1, wherein the LED module comprises:
a light-emitting diode (LED); and
a driving circuit, electrical connected to the LED, the first switch unit, and the second switch unit, in which the driving circuit receives the solar electric power generated by the solar module or the auxiliary electric power generated by the auxiliary power module to drive the LED to emit light.

6. The lighting apparatus as in claim 1, wherein the solar module comprises:
a solar panel, for receiving the light energy and converting the light energy into the electrical energy;
a power storage unit, electrically connected to the solar panel and the first switch unit, in which the power storage unit receives the electrical energy generated by the solar panel for generating the solar electric power; and
a charging circuit, electrically connected between the solar panel and the power storage unit, in which the charging circuit transmits the electrical energy generated by the solar panel to the power storage unit.

7. The lighting apparatus as in claim 6, wherein the solar module further includes a power leakage unit electrically connected to the power storage unit and the voltage level detection circuit, in which the power leakage unit discharges the power storage unit when the first switch unit is turned off and the second switch unit is turned on.

8. The lighting apparatus as in claim 1, wherein the auxiliary power module comprises:
a power source connection port, for connecting the power source; and
a direct current (DC) power supply circuit electrically connected to the exterior power source connection port and the second switch unit, in which the DC power supply circuit receives the power of the power source from the exterior power source connection port, for generating the auxiliary electric power and an operating voltage for the electric power selection circuit.

9. The lighting apparatus as in claim 1, further comprising a first photo sensor unit electrically connected to the LED module, in which the first photo sensor unit stops the LED module from operating when the first photo sensor unit detects that an environmental light intensity is greater than a first threshold value.

10. A hybrid power supply device, electrically connected to a power utilizing load, comprising:
a solar module, for receiving a light energy and converting the light energy into an electrical energy, in order to output a solar electric power;
an auxiliary power module electrically connected to an exterior power source, in which the auxiliary power module receives a power of the exterior power source for generating an auxiliary electric power; and
an electric power selection circuit electrically connected to the power utilizing load, the solar module, and the auxiliary power module, in which the electric power selection circuit determines whether to output the auxiliary electric power or the solar electric power to the power utilizing load according to a voltage of the solar electric power.

11. The hybrid power supply device as in claim 10, wherein the electric power selection circuit comprises:
a first switch unit electrically connected between the solar module and the power utilizing load;
a second switch unit, electrically connected between the auxiliary power module and the power utilizing load; and
a voltage level detection circuit, electrically connected to the solar module, the first switch unit, and the second switch unit, in which the voltage level detection circuit compares the voltage of the solar electric power with a predetermined value for generating a comparison result, and controls the first switch unit and the second switch unit according to the comparison result.

12. The hybrid power supply device as in claim 10, wherein the electric power selection circuit comprises:
a 2-to-1 multiplexer, having a first input end, a second input end, a control end, and an output end, in which the output end is electrically connected to the power utilizing load, the first input end is electrically connected to the solar module, and the second input end is electrically connected to the auxiliary power module; and
a voltage level detection circuit electrically connected to the solar module and the control end, in which the voltage level detection circuit generates a selection signal according to the voltage of the solar electric power, and controls the 2-to-1 multiplexer for outputting the solar electric power and the auxiliary electric power to the power utilizing load according to the selection signal.

13. The hybrid power supply device as in claim 11, wherein when the comparison result indicates that the voltage of the solar electric power is greater than the predetermined value, the voltage level detection circuit turns on the first switch unit and turns off the second switch unit, otherwise the voltage level detection circuit turns off the first switch unit and turns on the second switch unit.

14. The hybrid power supply device as in claim 10, wherein the solar module comprising:
a solar panel, for receiving the light energy and converting the light energy into the electrical energy;
a power storage unit, electrically connected to the solar panel and the first switch unit, in which the power storage unit receives the electrical energy generated by the solar panel for generating the solar electric power; and
a charging circuit, electrically connected between the solar panel and the power storage unit, in which the charging circuit transmits the electrical energy generated by the solar panel to the power storage unit.

15. The hybrid power supply device as in claim 14, wherein the solar module further includes a power leakage unit electrically connected to the power storage unit and the voltage level detection circuit, in which the power leakage unit discharges the power storage unit when the first switch unit is turned off and the second switch unit is turned on.

16. The hybrid power supply device as in claim 10, wherein the auxiliary power module comprises:
a power source connection port, for connecting the exterior power source; and
a direct current (DC) power supply circuit electrically connected to the power source connection port and the second switch unit, in which the DC power supply circuit receives the power of the power source from the power source connection port, for generating the auxiliary electric power and an operating voltage for the electric power selection circuit.

17. A hybrid power supply method for providing electric power to a light-emitting diode (LED) module by a hybrid power supply device including a solar module, an auxiliary power module, a first switch unit, a second switch unit, and a voltage level detection circuit, in which the first switch unit is electrically connected between the solar module and the LED module, and the second switch unit is electrically connected between the auxiliary power module and the LED module, the method comprising:
comparing a voltage of a solar electric power generated by the solar module with a predetermined value by the voltage level detection circuit, for generating a comparison result; and
controlling the first switch unit and the second switch unit according to the comparison result by the voltage level detection circuit, for determining whether to transmit the solar electric power generated by the solar module or an auxiliary electric power generated by the auxiliary power module to the LED module.

18. The hybrid power supply method as in claim 17, wherein when the voltage of the solar electric power is greater than the predetermined value causing the voltage level detection circuit to turn on the first switch unit and to turn off the second switch unit, for transmitting the solar electric power to the LED module, otherwise causing the voltage level detection circuit to turn off the first switch unit and to turn on the second switch unit, for transmitting the auxiliary electric power to the LED module.

19. The hybrid power supply method as in claim 17, further comprising:
controlling a power leakage unit by the voltage level detection circuit for discharging electric power stored in the solar module when the first switch unit is turned off and the second switch unit is turned on.

20. The hybrid power supply method as in claim 17, further comprising:
detecting an environmental light intensity by a photo sensor unit of the hybrid power supply device; and
stopping the auxiliary power module from operating by the photo sensor unit when the environmental light intensity is greater than a threshold value.
